(19) United States
(12) Patent Application Publication
(10) Pub. No.: US 2013/0161982 A1
(43) Pub. Date: Jun. 27, 2013

(54) Tilt-and-Slide Sunroof for a Vehicle, Comprising a Roof Opening, in Which a Central Beam is Arranged

(71) Applicant: Bayerische Motoren Werke Aktiengesellschaft, Muenchen (DE)

(72) Inventors: Alexander WALTER, Muenchen (DE); Johann MINATTI, Muenchen (DE)

(73) Assignee: BAYERISCHE MOTOREN WERKE AKTIENGESELLSCHAFT, Muenchen (DE)

(21) Appl. No.: 13/767,229

(22) Filed: Feb. 14, 2013

Related U.S. Application Data
(63) Continuation of application No. PCT/EP2011/064221, filed on Aug. 18, 2011.

(30) Foreign Application Priority Data
Aug. 25, 2010 (DE) 10 2010 039 726.1

(51) Int. Cl. B60J 7/043

(52) U.S. Cl. CPC B60J 7/043
USPC 296/217; 296/216.03

(57) ABSTRACT

A tilt-and-slide vehicle sunroof has a cover that closes a roof opening in which a central beam is arranged. The rear edge of the cover is moveable upwards out of the roof opening and backwards. The sunroof has a central beam guide in the central beam, which runs approximately in the vehicle longitudinal direction and in which a sliding element is guided. The sliding element is connected to a laterally central front lower region of the cover directly or via at least one intermediate part in a fixed, pivotable, and/or height adjustable manner. A guide part arranged in a laterally central region of the vehicle at a distance behind the sliding element is guided in the central beam guide or in a roof longitudinal guide and is connectable to the cover directly or via a connecting part in a longitudinally displaceable, pivotable, and/or height adjustable manner relative to the cover.

### CROSS REFERENCE TO RELATED APPLICATIONS

This application is a continuation of PCT International Application No. PCT/EP2011/064221, filed Aug. 18, 2011, which claims priority under 35 U.S.C. §119 from German Patent Application No. DE 10 2010 039 726.1, filed Aug. 25, 2010, the entire disclosures of which are herein expressly incorporated by reference.

### BACKGROUND AND SUMMARY OF THE INVENTION

The invention relates to a tilt-and-slide sunroof that is configured for a vehicle, and includes a roof opening, which can be closed by a cover and in which a central beam is arranged.

A tilt-and-slide sunroof of this type is disclosed in EP 1 564 051 A2. In this case, the sunroof has a cover, which closes a roof opening in its closed position and, after extending its rear edge to the rear, can be moved into an open position. In order to guide the cover, a central beam guide is arranged in a laterally middle central beam in the roof opening; and a sliding element, which is connected to the cover, slides along in this central beam guide. A motor-generated operating force is produced at the cover via a toothed belt in the central beam guide; and this cover can be moved by a motor-generated drive supported in the rear region of the central beam. In order to further guide the cover, the two rear side regions of the cover are provided with extension levers, which are guided in a longitudinally adjustable manner in the open topped roof guides in the roof region behind the roof opening. These levers ought to be visible and accessible to a person located laterally next to the vehicle and, optionally or in addition, are perceived to be visually annoying. Owing to the lateral arrangement of the roof guides, they are less protected and may collect leaves, falling sideways off the central roof region, or dirt may be thrown up from the roadway, so that a longitudinal movement of the extension levers or more specifically their sliding elements may become difficult or, in certain circumstances, may even be prevented. It is also possible that parts of the adjusting mechanism of the roof will be damaged. In order to prevent such damage, both roof guides will eventually need covers. In particular, the lateral adjusting mechanisms for the cover require an installation space that restricts the head room of the persons located in the passenger compartment. The tilt-and-slide sunroof needs a number of components that are labor intensive to manufacture and, hence, incur corresponding expenses.

The object of the present invention is to provide a tilt-and-slide sunroof that exhibits the features discussed above and that uses a small number of components, all of which are cost effective to produce and do not restrict, or do not restrict as much, the head room of the person sitting in the passenger compartment.

This and other objects are achieved by a tilt-and-slide sunroof according to the invention comprising a roof opening, which can be closed by a cover and in which a central beam is arranged. The rear edge of the cover can be extended upwards out of the roof opening and can be moved back. The central beam has a central beam guide, which runs approximately in the longitudinal direction of the vehicle and in which at least one sliding element is guided. The sliding element is connected to a laterally central, front lower region of the cover directly or via at least one intermediate part in a fixed manner or in a pivotable manner about a real or virtual pivoting axis, which runs in the transverse direction of the vehicle, or additionally in a height adjustable manner. A guide part is arranged in a laterally central region of the vehicle at a distance behind the sliding element. The guide part is guided in the central beam guide or in an additional central beam guide in the central beam or in a longitudinal roof guide on the exterior of a roof region behind the roof opening approximately in the longitudinal direction of the vehicle and is connected or can be connected to the cover directly or via at least one connecting part in a longitudinally displaceable manner and/or in a pivotable manner about a real or virtual pivoting axis, which runs in the transverse direction of the vehicle, or additionally in a height adjustable manner relative to the cover.

As a result, the tilt-and-slide sunroof needs only one front, laterally central guide mechanism, which is formed by way of the sliding element that engages with a central beam guide, and optionally by way of the at least one intermediate part, which is connected at least indirectly to the sliding element and the cover, and downstream thereof at a distance from the sliding element a rear, laterally central guide mechanism, which is formed by the guide part, which is guided in a laterally central region of the vehicle in the longitudinal direction of the vehicle and which is connected or can be connected at least indirectly to the guide part and the cover, optionally or in addition, by way of a connecting part.

Such a tilt-and-slide sunroof with only two guide mechanisms has only a small number of easy to produce components that are arranged in a laterally central region of the vehicle such that the head room of the persons located in the passenger compartment is not restricted or is less restricted. The sliding element and the central beam guide(s), as well as the guide part and optionally the longitudinal roof guide, can be configured such that the cover is secured in a stable manner in the event of any and all expected impact forces and/or moments.

It is also possible to provide the laterally central region of the vehicle with a plurality of, preferably two, central beam guides in a preferably joint central beam in the roof opening and/or a plurality of, preferably two, longitudinal roof guides behind the roof opening. In this case either two sliding elements, which are arranged so as to be spaced apart next to each other, or two guide parts, which are arranged so as to be spaced apart next to each other, engage with the roof opening in the front region of the cover and/or in the central to rear region of the cover. Then, the two sliding elements or the two guide parts are connected directly or by way of at least one intermediate part and/or connecting part indirectly to the cover in a manner specified for a single sliding element or a single guide part respectively.

In an especially advantageous embodiment, the at least one sliding element and the at least one guide part are arranged in a joint central beam in such a way that they can be moved longitudinally only in a front and central to rear region in the central beam guides. In this case the central beam is arranged in the laterally central region of the roof opening. Here, an additional longitudinal roof guide is not necessary and, therefore, not provided. When the cover is closed, the central beam guides are covered by the cover, so that they are protected. When the cover is open and in the case that at least one laterally central longitudinal roof guide is provided behind the roof opening, the guides are arranged laterally approximately in the center of the vehicle in a more protected way than when arranged laterally outwards as is the case in the state of the art. In case it is necessary, with the use of at least one longitudinal roof guide, to provide the longitudinal roof guide(s) with a cover, which is, for example, movable, then this cover can be formed by a single central cover.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a perspective, simplified view of a first exemplary embodiment of a tilt-and-slide sunroof of a motor vehicle with the cover located in the open position;

FIG. 2 is a side view of the tilt-and-slide sunroof shown in FIG. 1;

FIG. 3 is a perspective view of the cover, according to FIGS. 1 and 2, from the rear left hand corner from below;

FIG. 4 is a simplified top view of a second exemplary embodiment of the tilt-and-slide sunroof of a motor vehicle with the cover in the closed state;

FIG. 5 is a view, according to FIG. 4, with the cover located in the open position; and

FIG. 6 is a simplified lateral sectional view of the closed tilt-and-slide sunroof in FIG. 4.

### DETAILED DESCRIPTION OF THE DRAWINGS

FIG. 1 is a perspective, simplified view of a first exemplary embodiment of a tilt-and-slide sunroof that is configured for a motor vehicle. The sunroof comprises a roof opening 2 that can be closed by a cover 1. The figure shows very clearly that a central beam 3, which extends at least from a front bottom to a rear bottom edge region of the roof opening 2, is located in the lateral middle of the roof opening 2. In the figure, the cover 1 is in its open position, which is a maximum open position, up to which the cover 1 can be moved to the rear, if beforehand the rear edge 4 of the closed cover 1 had been extended upwards out of the roof opening 2. For this purpose there is an arbitrary adjusting mechanism, which is not shown and can correspond, for example, to the state of the art. When the cover 1 is in the open position, the roof opening 2 is open in a larger region. This arrangement makes it possible to take air into or blow air out of the passenger compartment. In addition, a person, who is located in the passenger compartment, can clearly see the environment through the open roof opening 2.

Two sliding elements 7, 8 or 9, 10 respectively, which are very plain to see in FIG. 3, are symmetrically spaced apart from each other at a lateral distance in an open topped central beam guide 5, 6, which is arranged in the central beam 3 and extends approximately in the longitudinal direction of the vehicle. The sliding elements can be moved longitudinally in approximately the longitudinal direction of the vehicle. These sliding elements are connected to an assigned, laterally central supporting arm 15 or 16 respectively in such a way that the sliding elements can be pivoted in pairs about a sliding element axis 11, 12 or 13, 14, respectively, which extends in the transverse direction of the vehicle, in the front lower region of the cover 1. These sliding elements 7, 8 or 9, 10 are fastened to the underside of a laterally central region 17 of the cover 1 and are covered by this central region 17 of the cover 1.

At a distance behind the front sliding elements 7, 8 or 9, 10 respectively there are two additional guide parts that are symmetrically spaced apart from each other at a lateral distance in a laterally central region of the vehicle. These additional guide parts cannot be seen in the figures, but engage in a manner analogous to the front sliding elements 7, 8 or 9, 10 respectively in pairs with an assigned central beam guide 5 or 6 respectively or with an assigned additional central beam guide in the central beam 3 in such a way that the additional guide parts can be moved longitudinally in approximately the longitudinal direction of the vehicle.

These additional sliding elements, or more specifically these rear sliding elements, can be connected to the cover 1 by way of an additional adjusting mechanism with at least one connecting part in a longitudinally displaceable manner and/or in a pivotable manner about a real or virtual, stationary or moveable, pivoting axis, which runs in the transverse direction of the vehicle, or additionally in a height adjustable manner relative to the cover. Or, for example, prior to or in the course of extending the rear edge of the closed cover upwards out of the roof opening, these sliding elements can be connected to the cover 1 by way of a coupling device, which is not depicted. In the latter case this connection of the connecting part to the cover 1 on closing the opened cover 1 can be released from the cover 1 by a decoupling device, which is not depicted. The details regarding this additional adjusting mechanism, or more specifically the coupling device and the decoupling device, are not shown in the figures, because the additional adjusting mechanism, or more specifically the coupling device and the decoupling device, can be, for example, a known adjusting mechanism that corresponds to the state of the art.

In the exemplary embodiment, the additional cover mechanism, which includes at least one connecting part, has a connecting part 18, 19, which is very plain to see in FIG. 3; and this connecting part 18, 19 is guided in an assigned additional longitudinal cover guide 20 or 21 respectively on the underside of the cover 1 in such a way that the connecting part can be moved longitudinally relative to an approximately longitudinal direction of the cover 1. In this case when the cover 1, which is extended upwards at its rear edge 4, is moved back, a retaining device, which is not depicted, securely holds the guide part (not depicted), which is assigned to the connecting part 18 or 19 respectively, in its longitudinal position, which is reached after extending the rear edge of the cover 1, in the assigned central beam guide 5 or 6 respectively or in an assigned additional central beam guide.

It is very plain to see in FIG. 1 that the roof opening 1 is formed in a front region of the vehicle roof and is defined, according to FIG. 3, laterally outwards as well as in the front and at the rear by a frame part 22 of the vehicle roof.

FIGS. 1 and 3 show that the cover 1 includes two cover regions 23, 24, which are laterally spaced apart from each other and which are formed in such a way that the cover regions are at least partially transmissive to light. Below the light transmissive cover regions 23, 24 of the closed cover 1 a cover part (not depicted), which is assigned separately to a light transmissive cover region 23 or 24 respectively, can be moved, for example, can be rolled up, between an open position, which releases at least for the most part the assigned cover region 23 or 24 respectively, and a closed position, which closes at least for the most part the assigned cover region 23 or 24 respectively. The two separate cover parts can be arranged in such a way that they can be moved, for example, rolled up in the longitudinal direction of the vehicle or in the transverse direction of the vehicle.

The two separate cover parts can be connected directly or indirectly to a guide element at least at a front region; and this guide element is guided in a longitudinally displaceable manner in an assigned longitudinal guide in the central beam.

The closed and/or at least partially opened cover 1 can be locked at its lateral regions on an adjacent lateral longitudinal roof strut of the roof of the vehicle.

The lateral regions of the cover 1 can have in each case at least one support face, which is not depicted. When the cover 1 is closed and/or when the cover 1 is at least partially open, the support face is supported individually or at least partially together with other such support faces on at least one counter-support face on an adjacent longitudinal roof strut of the vehicle roof in a continuous manner or at least after a small rolling movement of the cover 1 about an ideal longitudinal axis of the vehicle, where the rolling movement is caused, for example, by wind forces.

A seal (not depicted) of the peripheral region of the closed cover 1 is produced by at least one sealing element in the peripheral region of the cover 1 and/or at an edge of the roof opening 2 or more specifically at a roof cassette, which supports the cover 1 in a moveable manner, or, in the absence of a roof cassette, at a component of the vehicle. In addition, water, which has entered through a gap between the roof opening 2 and the cover 1, is drained outwards and/or downwards eventually into a cavity, which is connected to the surrounding area, by way of a water draining device (not depicted) comprising suitable water conducting walls at a roof cassette supporting the cover 1, or, in the absence of a roof cassette, by water conducting walls at a vehicle component.

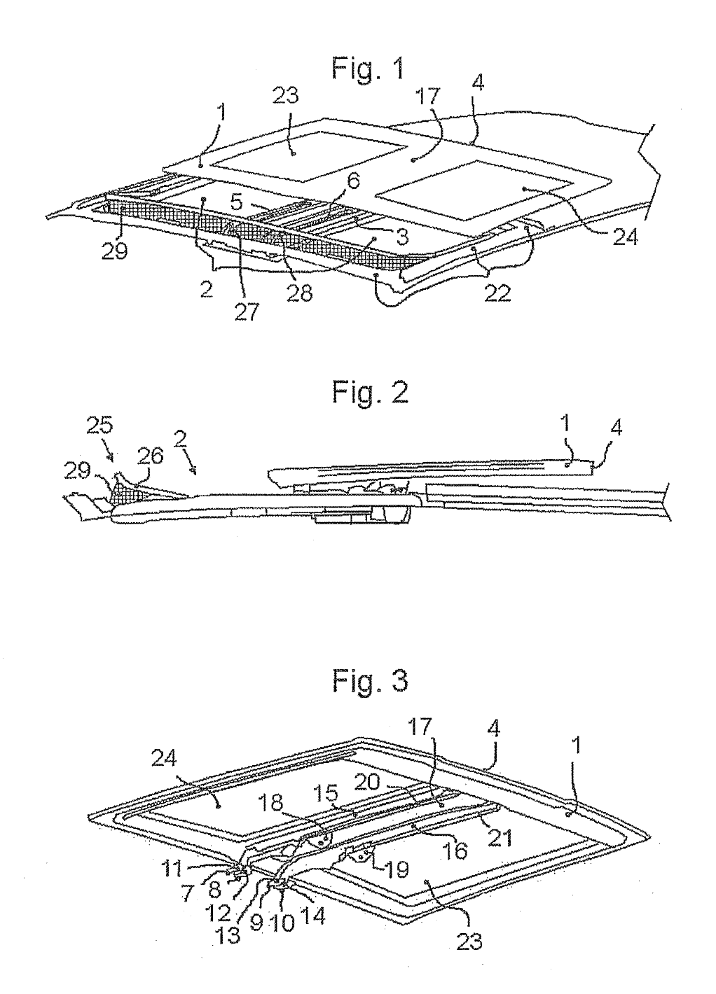

According to FIGS. 1 and 2, the front region of the roof opening 2 has a wind deflector 25, which is spring-loaded in the illustrated extended position; and on closing the opened cover 1, this wind deflector can be moved into a retracted position by the cover 1 or by an adjusting device. In the exemplary embodiment the wind deflector includes a U-shaped bracket 26, of which the leg end regions are arranged on the vehicle roof in a pivotable manner and which is loaded upwards into the extended position by a spring element (not shown). Between the base and the legs of the brackets 26 there is, for example, a wind deflecting net 29, which can be, for example, folded and/or can be stretched; and the lower edge region of the winding deflecting net is fastened to the vehicle roof or more specifically to the roof cassette. On closing the opened cover 1, the bracket 26 is moved in interaction with the cover 1 or by an adjusting mechanism into its retracted position downwards into a position that is, for example, approximately horizontal.

It is very plain to see from FIG. 1 that in the exemplary embodiment the open topped central beam guide 5, 6, which extends in approximately the longitudinal direction of the vehicle, runs in the central beam 3 in such a way that the front guide regions 27, 28 of the central beam guide are curved in each case downwards to the front.

The result of this feature is that when the cover 1, which is extended upwards at its rear edge 4, is moved rearward, the front region of the cover 1 is lifted towards the rear by means of the sliding elements 7, 8, 9, 10, which slide in pairs along the curved guide regions 27, 28. When the cover 1 is moved back into the roof opening 2, it is lowered approximately flush with the outer skin.

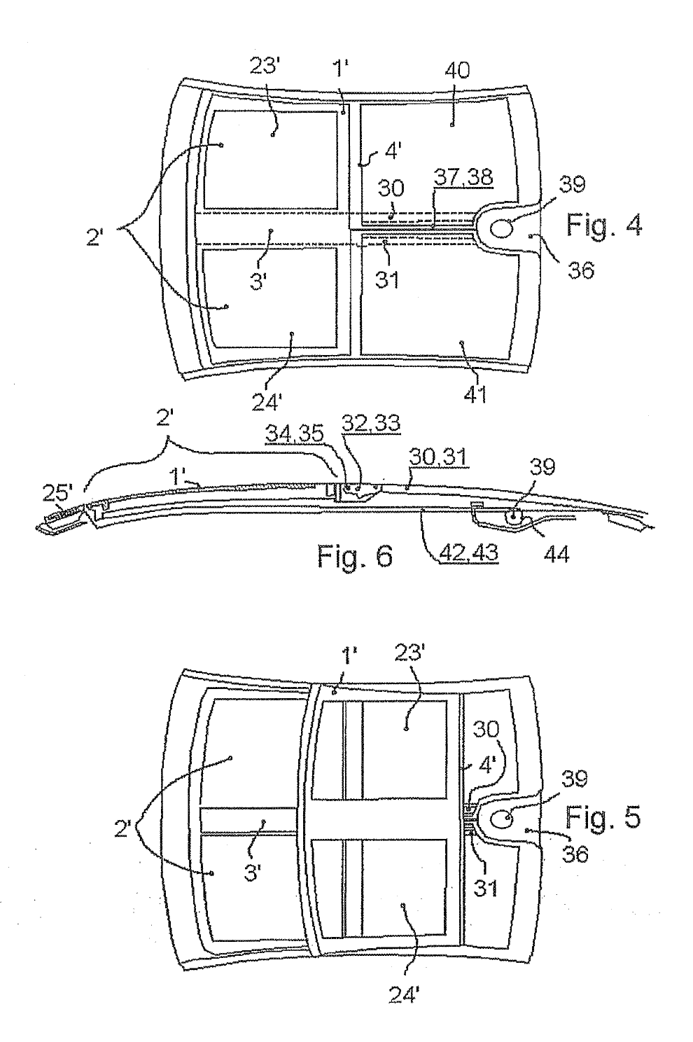

A second exemplary embodiment of the invention is described below with reference to FIGS. 4 to 6. Like reference numbers are used to identify the same or similar components as those of the first exemplary embodiment.

In the second exemplary embodiment, the cover 1′ is supported, as in the first exemplary embodiment, at its front, laterally central region and can also be extended upwards at its rear edge 4′ out of a closed position, which closes the roof opening 2′; and the cover can be moved back again.

In the second exemplary embodiment, two guide parts (not depicted) are arranged in pairs laterally adjacent to each other at a distance behind the front sliding elements (not depicted) in a laterally central region of the vehicle. These pairs of guide parts are guided in an open topped longitudinal roof guide 30, 31 on the exterior of a roof region behind the roof opening 2′ in approximately the longitudinal direction of the vehicle. Moreover, the guide parts are connected to the cover 1′ directly or by way of at least one connecting part 32 or 33 respectively in a longitudinally displaceable manner and/or in a pivotable manner about a real or virtual pivoting axis 34 or 35 respectively, which runs in the transverse direction of the vehicle, or additionally in a height adjustable manner relative to the cover; or, for example, in the course of extending the cover 1′ the guide parts can be connected to the cover 1′ by way of a coupling device (not depicted).

In the latter case a decoupling device (not shown) causes the connecting parts 32, 33 to be released from the cover 1′, when the cover 1′ is closed and additionally is lowered into the roof opening 2′. The rear guide parts (not illustrated) can be moved only slightly in the longitudinal direction relative to the cover 1′ approximately in the longitudinal direction of the vehicle in an assigned longitudinal roof guide 30 or 31 respectively and eventually in the rear region of the central beam 3′ in an assigned central beam guide or in an additional central beam guide in such a way that the cover 1′ is extended with its rear edge 4′ upwards out of the roof opening 2′ or is lowered into the roof opening 2′. In this case the front region of the cover 2′ can be securely held and/or fixed, for example, in the longitudinal position of the cover, so that the front region of the cover remains approximately in its vertical position and does not compress or does not unduly compress a front seal.

When moving the cover 1′, which is extended upwards at its rear edge 4′ and is released towards the rear for a longitudinal movement, the distance between the front sliding elements (not depicted) and the rear guide parts (not depicted), which in this case slide in the assigned longitudinal roof guides 30, 31 or, as an alternative, in additional longitudinal roof guides, which are open at the top, does not change or does not change significantly.

In the exemplary embodiment an adjusting force, which acts on the cover 1′, is generated by a motor 39, which is arranged, for example, below the rear central roof region 36. This motor is, for example, an electric motor and is connected to at least one rear guide part (not depicted) or at least one front sliding element (not depicted) in such a way that the force is transferred at least by way of at least one cable 37 or one toothed belt 38.

In the second exemplary embodiment the cover 1′ comprises two cover regions 23′, 24′ which are laterally spaced apart from each other and are formed in such a way that they are at least partially transmissive to light. In addition, the rear roof region comprises two roof sections 40, 41, which are laterally spaced apart from each other and are formed in such a way that they are at least partially transmissive to light.

On each side of the vehicle a laterally joint cover part 42 or 43 respectively can be moved below the light transmissive cover regions 23′, 24′ and below the light transmissive roof sections 40, 41 respectively; or in the exemplary embodiment the laterally joint cover part can be rolled up onto and rolled off of a laterally joint roller 44, shown in FIG. 6. In this case the respective laterally joint cover part 42 or 43 can be moved, as required, between an open position, which releases at least for the most part the assigned cover region 23′, 24′ or additionally the respective roof section 42 or 43, and a closed position, which closes at least for the most part the respective roof section 42 or 43 or additionally the assigned cover region 23′, 24′, or into an intermediate position.

It goes without saying that each of the light transmissive cover regions 23′, 24′ and the light transmissive rear roof sections 40, 41 can be assigned a separate moveable cover part; or a plurality of cover regions or all of the cover regions 23′, 24′ and the light transmissive rear roof sections 40, 41 can be assigned a joint cover part, which can be moved, for example, more or less in the longitudinal direction of the vehicle or in the transverse direction of the vehicle and/or can be rolled up onto a roller in this direction or can be rolled off of a roller. A joint or separate cover part can be connected directly or indirectly to the guide element at least at a front region; and this guide element is guided, for example, in an assigned longitudinal guide in the central beam in such a way that the guide element can be moved essentially in the longitudinal direction.

Additional measures provided in the first exemplary embodiment can also be provided in the second exemplary embodiment individually or in any combination in such a way these additional measures are jointly implemented directly or at least adapted to the second exemplary embodiment.

It goes without saying that the invention can be designed in such a way that it deviates more or less from the two exemplary embodiments. The central beam guides, which are open at the top in the exemplary embodiments, can also be designed in such a way that they are open at the top, the bottom and/or at the side according to at least one assigned direction. In a particularly simple design, there is only a single front sliding element and additionally only a single rear guide part, which can be easily configured so as to be stable in such a way that the cover is arranged without a lateral supporting face, which acts together with a counter-support face, or at least with such a support face that the cover is adequately secure against tilting in any adjustment position and/or is supported in such a way that it is tilt resistant immediately or at least after a small tilting movement. The roof opening can also be defined laterally by an upper window edge of a closed window pane in a closed side door of the vehicle. In this case the lateral roof struts, against which a frameless window pane in a vehicle side door rests, are connected to the cover to form a component. It is also contemplated that the roof opening is defined laterally by the frame of a window pane, which is provided with a frame, in a side door of the vehicle, when the side doors are closed. The vehicle can also be any type of vehicle, for example, a motor vehicle or more specifically a convertible. In the latter case the cover can be formed by a front stationary roof part or by a cover on a front stationary roof part. The at least one central beam guide can be formed on a front roof part of a convertible; and the at least one longitudinal roof guide, which is open at the top, can be configured at the same roof part or at an additional, in essence stationary roof part that is located behind the same roof part, so that the at least one additional roof part can be moved relative to the front roof part and vice versa in a random manner. The lateral cover regions of the cover can also include at least one support guide part. When the cover is closed, when the cover is extended with the rear edge and/or when the cover is partially moved back, the support guide part engages with a roof-sided support guide, which is formed in a side region of the roof opening and/or in a side region of the vehicle roof behind the roof opening, in such a way that the support guide part can be moved more or less in the longitudinal direction of the vehicle.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A tilt-and-slide sunroof for a vehicle, comprising:
a central beam arranged longitudinally in a center area of a roof opening in the vehicle;
a cover operatively configured to close the roof opening, wherein a rear edge of the cover is extendable upwards out of the roof opening and is moveable rearwardly relative to the vehicle;
a central beam guide arranged in the central beam, the central beam guide extending in a longitudinal direction of the vehicle;
a sliding element guided in the central beam guide, the sliding element being connected to a laterally central, front lower region of the cover in one of a fixed, pivotable, and height adjustable manner, the pivotable manner being about an axis extending in a transverse direction of the vehicle;
a guide part arranged in a laterally central region of the vehicle at a distance behind the sliding element, the guide part being guided in one of the central beam guide and a longitudinal roof guide, the longitudinal roof guide being arranged on an exterior of a roof region located behind the roof opening;
wherein the guide part is connectable to the cover in at least one of a longitudinally displaceable, pivotable, and height adjustable manner relative to the cover, the pivotable manner being about an axis extending in a transverse direction of the vehicle.

2. The tilt-and-slide sunroof according to claim 1, wherein the guide part is connectable to the cover via at least one connecting part.

3. The tilt-and-slide sunroof according to claim 1, wherein two central beam guides are arranged in the central beam, the two central beam guides being laterally open in at least one of an upward, downward, and a defined direction.

4. The tilt-and-slide sunroof according to claim 3, wherein the guide part is arranged in one of:
(a) a laterally central to rear region of the cover, and
(b) behind the cover when the cover is closed;
wherein the guide part is guided approximately in the longitudinal direction of the vehicle in one of the central beam guide and the longitudinal roof guide.

5. The tilt-and-slide sunroof according to claim 2, wherein when the guide part is connectable to the cover via the connecting part, the connecting part is movable longitudinally relative to the cover in an assigned longitudinal cover guide on an underside of the cover when the cover is moved rearwardly; and
wherein a retaining device is operatively configured to securely hold the guide part in its longitudinal position in the assigned central beam guide.

6. The tilt-and-slide sunroof according to claim 1, wherein the central beam extends at least from a front bottom edge region to a rear bottom edge region of the roof opening in a laterally central region of the roof opening.

7. The tilt-and-slide sunroof according to claim 1, wherein upon raising the rear edge of the cover out of the roof opening, a coupling device couples the guide part or a connecting part, which is released from the cover, to a rear region of the cover; and
wherein when the cover is moved back into the roof opening, a decoupling device releases the connecting part from the cover.

8. The tilt-and-slide sunroof according to claim 1, wherein the roof opening is in a front region of the vehicle roof.

9. The tilt-and-slide sunroof according to claim 1, wherein the roof opening is formed in a separate roof part of the vehicle roof, the roof part completely surrounding the roof opening.

10. The tilt-and-slide sunroof according to claim 1, wherein:
the roof opening is defined laterally by an upper window edge of a closed window pane in a closed side door of the vehicle;
at least one sealing part is fastened to lateral edges of the cover; and
an adjacent closed window pane of the closed vehicle door rests in a sealing manner against the sealing part.

11. The tilt-and-slide sunroof according to the claim 1, wherein the cover comprises:
at least two cover regions laterally spaced apart from one another and formed such that the cover regions are at least partially transmissive to light.

12. The tilt-and-slide sunroof according to claim 11, further comprising a cover part movable between an open position and a closed position for an assigned cover region;
wherein the cover part comprises at least one of a joint cover part or a single cover part.

13. The tilt-and-slide sunroof according to claim 11, wherein the cover part moves in one of a longitudinal and transverse direction of the vehicle.

14. The tilt-and-slide sunroof according to claim 11, wherein the cover part is connected to a guide element at least at a front region thereof; and
wherein the guide element is guided in an assigned longitudinal guide in the central beam such that the guide element is movable approximately in the longitudinal direction of the vehicle.

15. The tilt-and-slide sunroof according to claim 11, wherein lateral regions of the cover part are lockable at an adjacent lateral longitudinal roof strut of the vehicle roof.

16. The tilt-and-slide sunroof according to claim 1, wherein lateral regions of the cover have, in each case, a support face; and
when the cover is at least one of closed, open and partially open, the support face being supported on an assigned counter-support face on an adjacent longitudinal roof strut of the vehicle roof; and
wherein support of the support face occurs immediately or after a small rolling movement of the cover about an ideal longitudinal axis of the vehicle.

17. The tilt-and-slide sunroof according to claim 1, wherein lateral regions of the cover have a support guide part such that, when the cover is at least one of closed, extended with its rear edge, and partially moved back, the support guide part engages with a roof-sided support guide, the roof-sided support guide being formed in a side region of the roof opening or behind the roof opening; and
wherein the support guide part is movable substantially in the longitudinal direction of the vehicle.

18. The tilt-and-slide sunroof according to claim 1, further comprising a motor having a force transmission part operatively configured to move the cover; and
wherein the motor is arranged in a transverse direction of the vehicle approximately in a vehicle center behind the roof opening under a central to rear roof region of the vehicle.

19. The title-and-slide sunroof according to claim 1, further comprising:
a sealing element arranged to seal the cover in a closed position relative to the roof opening or a roof cassette in which the cover is movably mounted.

20. The tilt-and-slide sunroof according to claim 19, further comprising water conducting walls arranged in one of the roof cassette and a vehicle component, the water conducting walls being operatively configured to drain water that penetrates the roof opening when it is open.

21. The tilt-and-slide sunroof according to claim 1, further comprising:
a wind deflector arranged in a front region of the roof opening, the wind deflector being spring-loaded in an extended position; and
wherein on closing the cover, the wind deflector is movable into a retracted position.
